(19) United States
(12) Patent Application Publication
(10) Pub. No.: US 2025/0198524 A1
(43) Pub. Date: Jun. 19, 2025

(54) REMOVABLE VALVE SEAT INSERTS FOR PRESSURE AND VACUUM RELIEF VALVES

(71) Applicant: Fisher Jeon Gas Equipment (Chengdu) Co., Ltd., Chengdu (CN)

(72) Inventors: Guolei Fan, Chengdu (CN); Runtong Zhou, Chengdu (CN)

(21) Appl. No.: 18/980,860

(22) Filed: Dec. 13, 2024

(30) Foreign Application Priority Data
Dec. 14, 2023 (CN) 202323419966.2
Aug. 23, 2024 (CN) 202411168402.2

(51) Int. Cl. F16K 17/04; F16K 51/02

(52) U.S. Cl. CPC F16K 17/0466; F16K 51/02

(57) ABSTRACT

Removeable valve seat inserts for pressure and vacuum relief valves are disclosed. An example relief valve includes a valve body defining a fluid passageway between a first opening and a second opening, a valve seat coupled to the valve body at the first opening of the valve body, the valve seat having a cylindrical body, a seat insert disposed on an end of the valve seat, and a pallet moveable, based on a pressure differential across the pallet, between a closed position in which the pallet is engaged with the seat insert to block fluid flow through the valve seat and an open position in which the pallet is spaced from the seat insert to enable fluid flow through the valve seat.

### FIELD OF THE DISCLOSURE

This disclosure relates generally to valves and, more particularly, to removable seat inserts for pressure and vacuum relief valves.

### BACKGROUND

Relief valves are safety valves that regulate the pressure in vessels and/or flow systems. Pressure relief valves relieve excess pressure from a vessel and/or flow system by opening when the pressure of the system and/or vessel exceeds a set pressure. The opening of a pressure relief valve enables fluid to leave the flow system and/or vessel, which reduces the pressure of the flow system and/or vessel, and thereby prevents an over-pressurization scenario. Vacuum relief valves relieve an internal vacuum of a pressure vessel and/or flow system by opening when the pressure of the vessel and/or flow system becomes less than a set pressure. The opening of a vacuum relief valve enables ambient fluids to enter the flow system and/or vessel, which increases the pressure of the flow system and/or vessel. Relief valves enable flow systems and pressure vessels to have pressure within a predetermined range.

### SUMMARY SECTION

An example relief valve disclosed herein includes a valve body defining a fluid passageway between a first opening and a second opening, a valve seat coupled to the valve body at the first opening of the valve body, the valve seat having a cylindrical body, a seat insert disposed on an end of the valve seat, and a pallet moveable, based on a pressure differential across the pallet, between a closed position in which the pallet is engaged with the seat insert to block fluid flow through the valve seat and an open position in which the pallet is spaced from the seat insert to enable fluid flow through the valve seat.

An example pressure and vacuum relief valve disclosed herein includes a valve body defining a fluid passageway between a first opening, a second opening, and a third opening, the first opening to be fluidly connected to a pressure system, a first relief assembly to control fluid flow through the second opening, the first relief assembly including a valve seat having an end, a removeable insert disposed within the end, the removeable insert extending circumferentially within the valve seat, and a flow control member moveable between an open position and a closed position, the flow control member to form an interface with the removeable insert in the closed position, and a second relief assembly to control fluid flow through the third opening.

### BRIEF DESCRIPTION OF THE DRAWINGS

FIG. 1 is a cross-sectional view of an example pressure and vacuum relief valve including an example replaceable seat insert implemented in accordance with teachings of this disclosure.

FIG. 2 is a cross-sectional view of the example replaceable seat insert and an example valve seat of the example valve of FIG. 1.

FIG. 3 is a cross-sectional view of another example replaceable seat insert and clamp that can be implemented in connection with the example valve of FIG. 1.

FIG. 4 is a cross-sectional view of another example replaceable seat insert and a plurality of fasteners that can be implemented in connection with the example valve of FIG. 1.

FIG. 5A is a perspective view of another example replaceable seat insert disposed within an example valve seat that can be implemented in connection with the example valve of FIG. 1.

FIG. 5B is a cross-sectional view of the example replaceable seat insert of FIG. 5A disposed in the example valve seat.

FIG. 5C is an exploded view of the example replaceable seat insert and valve seat of FIG. 5A.

FIG. 6 is a perspective cross-sectional view of another example replaceable seat insert that can be implemented in connection with the example valve of FIG. 1.

In general, the same reference numbers will be used throughout the drawing(s) and accompanying written description to refer to the same or like parts. The figures are not necessarily to scale. Instead, the thickness of the layers or regions may be enlarged in the drawings. Although the figures show layers and regions with clean lines and boundaries, some or all of these lines and/or boundaries may be idealized. In reality, the boundaries and/or lines may be unobservable, blended, and/or irregular.

### DETAILED DESCRIPTION

Pressure systems (e.g., pressure lines, pressure vessels and/or piping systems) often include relief valves to protect the pressure system from pressure and/or vacuum buildup. The relief valves (e.g., pressure relief valves, vacuum relief valves, etc.) are self-actuated devices set to open when a pressure in the pressure system (e.g., the pressure vessel or pressure line) exceeds or falls below a pre-set pressure. For example, some fluids such as oil and gas are typically stored in large storage vessels. These fluids may emit vapor that could over-pressurize the storage vessel. Therefore, a pressure relief valve can be connected to the storage vessel. If the pressure in the storage vessel exceeds the pre-set pressure, the pressure relief valve opens to vent the vapor or gas buildup (e.g., to the atmosphere). Vacuum relief valves can similarly operate to protect against a vacuum or negative pressure in the storage vessel. Some relief valves include both a pressure relief valve and a vacuum relief valve, commonly referred to as a pressure and vacuum relief valve.

Some pressure and vacuum relief valves use one or more weight-loaded pallets to set the threshold pressures required to actuate the pallets from a resting closed position to an open position. In the closed position, a seal of the pallet rests upon a corresponding lip of a valve seat. When the pressure within the main chamber of the pressure and vacuum relief valve exerts a force on the pallet that overcomes the gravitational load associated with the weight, the corresponding pallet moves to an open position, which vents excess fluid from the pressure and vacuum relief valves (e.g., when the pressure relief pallet actuates, etc.) or enables entry of ambient fluid into the main chamber (e.g., when the vacuum relief flow control member actuates, etc.). After the off-pressure situation is rectified, the pressure of the main chamber of the pressure and vacuum relief valve returns to within a designated range, and the pallet of the pressure and vacuum relief valve closes. After repeated operation cycles (e.g., the opening and closing of a flow control member, etc.), the lip of the valve seat undergoes wear, which can reduce the efficacy of the seal of the pressure and vacuum relief valves. A worn valve seat can cause leakage between the main chamber of the relief valve into the atmosphere.

To prevent such leakage, the valve seat of prior valves must be periodically serviced and replaced. Because valve seats must form effective seals with the pallet, valve seats have tight (e.g., comparatively small, etc.) manufacturing tolerances and require comparatively smooth surface finishes. Some prior valve seats are manufactured via machining, which can require a relatively large amount of machining time to achieve the proper tolerances and surface finishes. Some prior valve seats are manufactured via casting, but require precise polishing and finishing to form an effective seal with the pallet. Accordingly, valve seats are relatively expensive parts that require periodic replacement over the life of a pressure and vacuum relief valve. The valve seats of some prior pressure and vacuum relief valves are frequently replaced due to wear from repeated opening and closing of the flow control member. Due to the manufacturing precision required to form sealing interfaces, prior valve seats are comparatively labor-intensive and, thus, costly components to manufacture.

Examples disclosed herein include pressure and vacuum relief valves with valve seat inserts that can be replaced instead of replacing the entirety of the valve seat. Some example seat inserts disclosed herein are coupled to a corresponding valve seat via an interference fit. Some example seat inserts disclosed herein are retained via a clamp disposed on an outer surface of a valve seat. Other example seat inserts disclosed are retained via a plurality of fasteners extending through the valve seat. Other example seat inserts disclosed herein are retained via a rotational lock interface with the valve seat. Examples disclosed herein reduce the maintenance costs of pressure and vacuum relief valves when compared to prior pressure and vacuum relief valves due to the comparatively small size and complexity of the seat insert when compared to the valve seat. Examples disclosed herein include valve seats with replaceable seat inserts for use with relief valves, such as pressure relief valves, vacuum relief valves, and/or pressure and vacuum relief valves. Examples disclosed herein include valve seats with an opening that receives a replaceable seat insert, which forms a sealing interface with a corresponding pallet. In some examples, a replaceable seat insert is constructed of a rigid material (e.g., a high performance thermoplastic (e.g., polyphenylene sulfide (PPS), etc.), a metal (e.g., a stainless steel, aluminum, etc.), and/or a ceramic, etc.). The replaceable seat insert forms a pressure-tight seal between the pallet and the lip of the valve seat. Therefore, any wear or degradation of the parts is biased to the replaceable seat insert rather than the valve seat. If an example replaceable seat insert becomes worn, the seat insert can be easily replaced with a new seat insert. As such, the entire valve seat does not need to be replaced as in known relief valves. The example replaceable seat inserts disclosed herein are relatively inexpensive to manufacture and install. This significantly reduces the maintenance costs of relief valves compared to known relief valves.

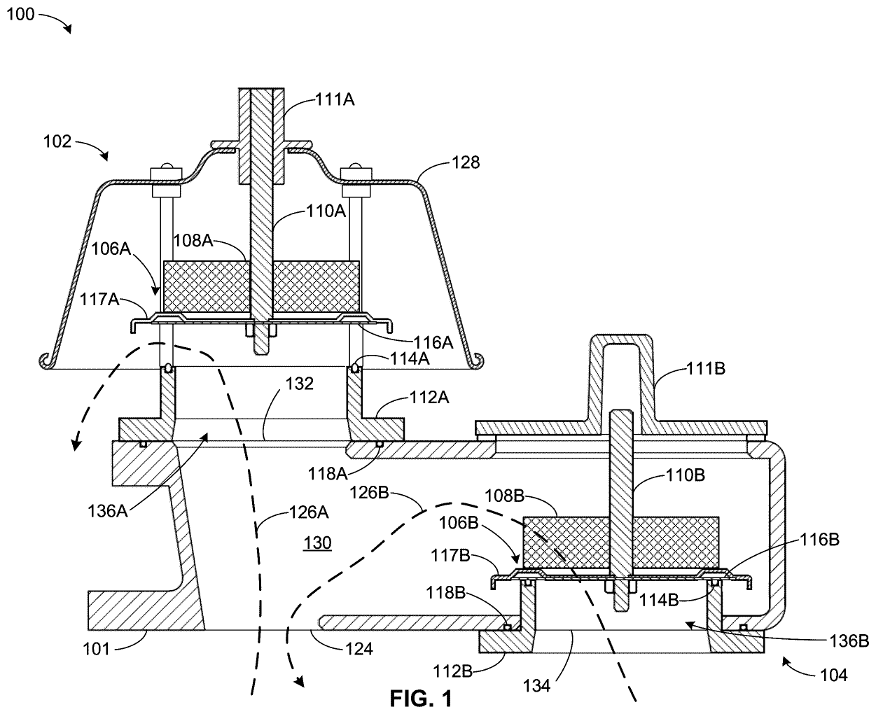

FIG. 1 is a cross-sectional front view of an example pressure and vacuum relief valve 100 implemented in accordance with teachings of this disclosure. In the illustrated example of FIG. 1, the pressure and vacuum relief valve 100 includes an example valve body 101, an example pressure relief assembly 102, and an example vacuum relief assembly 104. The valve body 101 defines a fluid passageway 130 (also referred to herein as the main chamber of the valve body) between an example first opening 124, an example second opening 132, and an example third opening 134. The first opening 124 can be fluidly coupled to a pressure system (e.g., a process pipe, a storage container or tank, etc.). Therefore, the fluid passageway 130 for the valve body 101 is at the same pressure as the pressure system. The pressure relief assembly 102 is coupled to the valve body 101 and controls fluid flow through the second opening 132 to provide pressure relief, and the vacuum relief assembly 104 is coupled to the valve body 101 and controls fluid flow through the third opening 134 to provide vacuum relief. The valve body 101 can be composed of any suitable rigid material, including aluminum, ductile iron, stainless steel, and/or carbon steel.

In the illustrated example of FIG. 1, the pressure relief assembly 102 includes an example first pallet 106A, an example first weight 108A, an example first valve stem 110A, an example first stem guide 111A, an example first valve seat 112A, and an example first seat insert 114A. The first valve seat 112A defines an example first orifice 136A and is coupled to the valve body 101 at the second opening 132. In the illustrated example of FIG. 1, the pressure relief assembly 102 includes an example first valve seat seal 118A between the first valve seat 112A and the valve body 101. In the illustrated example of FIG. 1, the first pallet 106A includes an example first pallet seal 116A and an example first plate 117A (e.g., a disc-shaped plate).

In the illustrated example of FIG. 1, the vacuum relief assembly 104 includes an example second pallet 106B, example second weight 108B, an example second valve stem 110B, an example second stem guide 111B, an example second valve seat 112B, and an example second seat insert 114B. The second valve seat 112B defines an example second orifice 136B and is coupled to the valve body 101 at the third opening 134. In the illustrated example, the vacuum relief assembly 104 includes a second valve seat seal 118B between the second valve seat 112B and the valve body 101. In the illustrated example of FIG. 1, the second pallet 106B includes an example second pallet seal 116B and an example second plate 117B. When the pressure relief assembly 102 is open, fluid can flow through the fluid passageway 130 along an example first fluid flow path 126A from the first opening 124 to the second opening 132 and through the pressure relief assembly 102. When the vacuum relief assembly 104 is open, fluid can flow through the fluid passageway 130 along an example second fluid flow path 126B from the third opening 134 to the first opening 124.

The pressure and vacuum relief valve 100 is a relief valve that can be used to regulate the pressure of a pressure vessel and/or a flow system. For example, the first opening 124 of the valve body 101 of the pressure and vacuum relief valve 100 can be fluidly coupled to a pressure vessel and/or fluid passageway associated with a flow system, such that a chamber of the valve body 101 includes fluid at a same pressure as the associated pressure vessel and/or fluid passageway. During the operation of the pressure and vacuum relief valve 100, the pressure of the fluid within the valve body 101 can cause the pressure relief assembly 102 (e.g., if the pressure in the fluid passageway 130 causes the pressure differential across the first pallet 106A to exceed the load associated with the first weight 108A, etc.) or the vacuum relief assembly 104 (e.g., if the pressure in the fluid passageway 130 causes the pressure differential across the first pallet 106A to exceed the load associated with the second weight 108B, etc.) to open, which causes the fluid within the valve body 101 to be vented via the first fluid flow path 126A or additional fluid to enter the valve body 101 via the third opening 134 via the second fluid flow path 126B, respectively.

While one example configuration of the pressure and vacuum relief valve 100 is depicted in FIG. 1, it should be appreciated that the teachings of this disclosure can be used in conjunction with valves having any other suitable configuration (e.g., a different geometry, etc.) and/or function (e.g., a different type of valve, etc.). In some examples, one of the pressure relief assembly 102 or the vacuum relief assembly 104 is absent. In such examples, the pressure and vacuum relief valve 100 can be a vacuum relief valve (e.g., if the pressure relief assembly 102 is absent, etc.) or a pressure relief valve (e.g., if the vacuum relief assembly 104 is absent, etc.).

In the illustrated example of FIG. 1, the pressure relief assembly 102 of the pressure and vacuum relief valve 100 regulates (e.g., protects, etc.) the coupled pressure vessel and/or flow system from excess pressure. In some such examples, if the pressure of the coupled system exceeds a threshold pressure (e.g., based on the mass of the first weight 108A, etc.), the pressure relief assembly 102 opens, which vents fluid from the valve body 101 from the pressure relief assembly 102 along the first fluid flow path 126A and out via the second opening 132.

In the illustrated example of FIG. 1, the pressure relief assembly 102 includes an example hood 128, which shields the pressure relief assembly 102 from inclement weather conditions (e.g., rain, snow, hail, etc.). In some examples, the hood 128 can be absent. In some examples, the second opening 132 can be fluidly coupled by a pipe to another location (e.g., a storage tank, another part of the flow system, etc.). Additionally or alternatively, the pressure and vacuum relief valve 100 can be disposed at a location that is not exposed to inclement weather (e.g., under a covered structure, inside, underground, etc.).

In the illustrated example of FIG. 1, the vacuum relief assembly 104 of the pressure and vacuum relief valve 100 regulates (e.g., protects, etc.) the coupled pressure vessel and/or flow system from a vacuum and/or under pressurization. In some such examples, if the pressure of the coupled system falls beneath a threshold pressure (e.g., based on the mass of the second weight 108B, etc.), the vacuum relief assembly 104 opens, which enables fluid (e.g., ambient air) to flow through the third opening 134 and into the valve body 101. In some examples, the third opening 134 can be exposed to the atmosphere. In some such examples, when the vacuum relief assembly 104 opens, air from the ambient environment can enter the fluid passageway 130 of the valve body 101, which increases the pressure of the fluid in the valve body 101 and the associated pressure vessel and/or flow system. In other examples, the second opening 132 can be coupled to a pipe and/or pressure vessel containing another fluid (e.g., an inert gas, a reserve of the fluid in the valve body 101, etc.). In some such examples, when the vacuum relief assembly 104 opens, the fluid flows into the pressure vessel through the third opening 134 and along the second fluid flow path 126B. In some examples, the third opening 134 can include a screen (not illustrated), which prevents particulate from flowing into the valve body 101 via the vacuum relief assembly 104.

The pallets 106A, 106B are flow control members that regulate the flow of fluid through the pressure relief assembly 102 and the vacuum relief assembly 104, respectively. In the illustrated example of FIG. 1, the pallets 106A, 106B are moveably coupled to the valve stems 110A, 110B, such that the pallets 106A, 106B more vertically (e.g., parallel to the gravitational vector, etc.) during operation. In other examples, the valve stems 110A, 110B can be disposed at any other suitable angle. In the illustrated example of FIG. 1, the weights 108A, 108B are disposed on the plates 117A, 117B of the pallets 106A, 106B, respectively, opposite the valve seats 112A, 112B, respectively. The pallets 106A, 106B are coupled to the valve stems 110A, 110B. During operation, the pallets 106A, 106B and the valve stems 110A, 110B move along the stem guides 111A, 111B, respectively, based on a pressure differential across/over the pallets 106A, 106B. The pallets 106A, 106B can be composed of any suitable rigid, corrosion resistant material, such as a high performance thermoplastic (e.g., polyphenylene sulfide (PPS), etc.), a metal (e.g., a stainless steel, aluminum, etc.), and/or a ceramic.

The weights 108A, 108B apply pressure to and bias the pallets 106A, 106B toward the valve seats 112A, 112B, respectively. That is, the weights 108A, 108B bias the pressure relief assembly 102 and the vacuum relief assembly 104 toward the closed position. As used herein, the pressure relief assembly 102 is “open” when the first pallet 106A is spaced from the first seat insert 114A (e.g., the first pallet 106A is not in contact with the first seat insert 114A, etc.). As used herein, the pressure relief assembly 102 is “closed” when the first pallet 106A is engaged with the first seat insert 114A (e.g., in contact with, abutting, etc.). In FIG. 1, the pressure relief assembly 102 is shown in the open state. Similarly, as used herein, the vacuum relief assembly 104 is “open” when the second pallet 106B is spaced from the second seat insert 114B and “closed” when the second pallet 106B is engaged with the second seat insert 114B (e.g., in contact with, abutting, etc.). In FIG. 1, the vacuum relief assembly 104 is shown in the closed state. When the pressure relief assembly 102 and the vacuum relief assembly 104 are closed, fluid is blocked from flowing through (1) the second opening 132 and the first valve seat 112A and (2) the third opening 134 and the second valve seat 112B, respectively. When the pressure relief assembly 102 is open, fluid is able to flow through second opening 132 and the first valve seat 112A. When the vacuum relief assembly 104 is open, the third opening 134 and the second valve seat 112B, respectively.

The weight 108A, 108B apply a pressure to the pallets 106A, 106B opposite the pressure exerted by the fluid of the valve body 101 of the pressure and vacuum relief valve 100. The mass of the weight 108A, 108B can be used to set the threshold pressures of the pressure relief assembly 102 and the vacuum relief assembly 104, respectively. For example, because the first weight 108A biases the pressure relief assembly 102 toward the closed position, increasing the mass of the weight 108A increases the amount of pressure (e.g., the excess pressure threshold, a first pressure threshold, etc.) required to open the pressure relief assembly 102. As such, by adjusting the mass of the first weight 108A, the threshold pressure to operate the pressure relief assembly 102 can be adjusted. Similarly, because the second weight 108B biases the vacuum relief assembly 104 toward the closed position, increasing the mass of the second weight 108B increases the amount of pressure (e.g., the under-pressure threshold, a second pressure threshold, etc.) required to open the vacuum relief assembly 104. The weights 108A, 108B can be composed of any suitably dense and corrosion-resistant material, such as zinc-plated carbon steel, plated iron, stainless steel, and/or lead.

In the illustrated example of FIG. 1, the valve seats 112A, 112B are coupled to the valve body 101 at the second opening 132 and the third opening 134, respectively. In the illustrated example of FIG. 1, the valve seats 112A, 112B are discrete components that are coupled to the valve body 101. In some such examples, the valve seats 112A, 112B can be coupled to the valve body 101 via one or more welds, one or more fasteners, one or more interference fits, etc. The example valve seat seals 118A, 118B mitigate (e.g., prevent, reduce, etc.) leaks between the interface between the valve seats 112A, 112B. In other examples, one or both of the valve seats 112A, 112B can be integral with the valve body 101. In such examples, corresponding ones of the valve seat seals 118A, 118B can be absent. In the illustrated examples, the valve seats 112A, 112B are cylindrically shaped (e.g., the valve seats 112A, 112B have cylindrical bodies. In other examples, the valve seats 112A, 112B can any other suitable shape (e.g., elliptical, polygonal, etc.). The valve seats 112A, 112B can be composed of any suitable rigid material, including aluminum, ductile iron, stainless steel, and/or carbon steel.

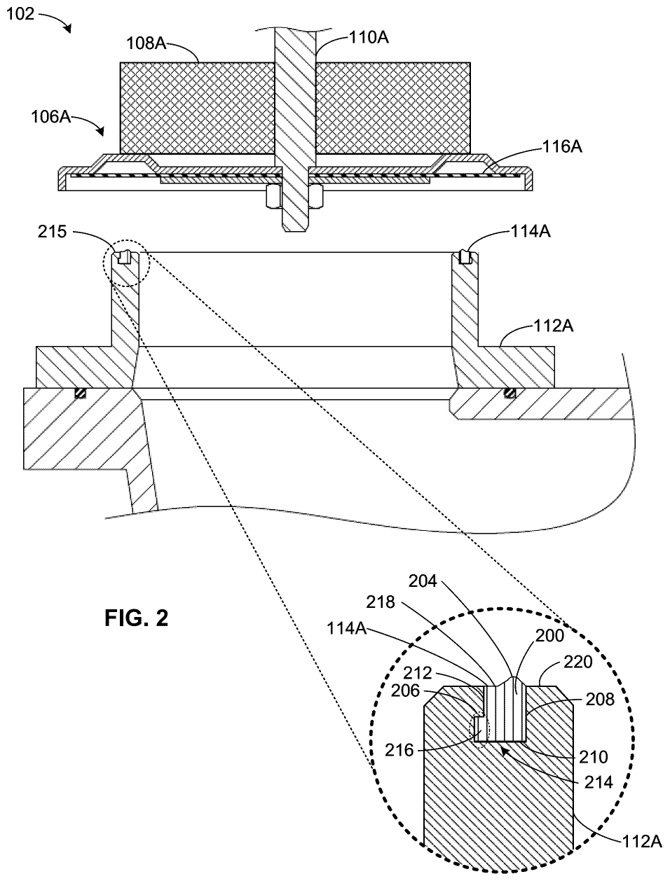

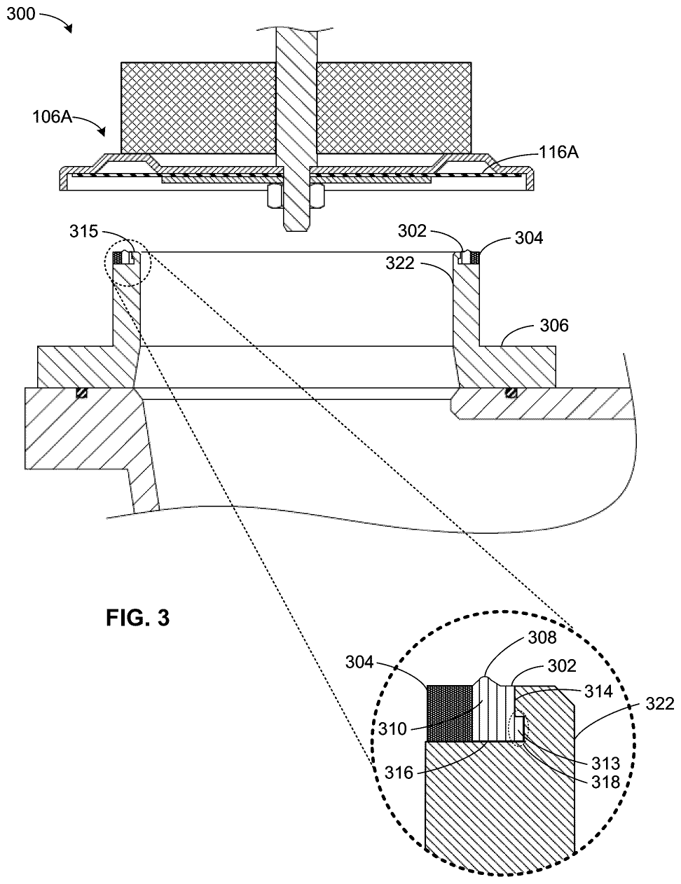

The seat inserts 114A, 114B are annular components that are removably coupled to the valve seats 112A, 112B (e.g., the seat inserts 114A, 114B are removeable inserts, etc.), respectively, and prevent fluid communication through the openings 132, 134 when the relief assemblies 102, 104 are closed, respectively. The seat inserts 114A, 114B can be composed of any suitable rigid and corrosion-resistant material, such as a high-performance thermoplastic (e.g., polyphenylene sulfide (PPS), etc.), a metal (e.g., a stainless steel, aluminum, a copper alloy, etc.), and/or a ceramic. The seat insert 114A is described in greater detail below in conjunction with FIG. 2. Other example seat inserts that can be used in conjunction with one or more of the relief assemblies 102, 104, and/or the pressure and vacuum relief valve 100 are described below in conjunction with FIGS. 3-6. In the illustrated example of FIG. 1, the seat inserts 114A, 114B have a same size and shape (e.g., the seat inserts 114A, 114B are interchangeable, etc.).

The pallet seals 116A, 116B are disposed on a bottom surface of the plates 117A, 117B of the pallets 106A, 106B, respectively, opposite corresponding ones of the weight 108A, 108B. In the illustrated example of FIG. 1, the pallet seals 116A, 116B are annular components that are disposed on a bottom surface of the plates 117A, 117B, respectively. In other examples, the pallet seals 116A, 116B can be coupled to the pallets 106A, 106B in any other suitable manner. The pallet seals 116A, 116B can be composed of any elastomer, including fluorinated ethylene propylene (FEP), natural rubber, nitrile rubber, a fluorocarbon (e.g., fluorine rubber, etc.), etc. The interface between the first seat insert 114A and the first pallet seal 116A is described below in additional detail in conjunction with FIG. 2.

During the operation of the pressure and vacuum relief valve 100, the relief assemblies 102, 104 cycle between the open and closed positions, which can cause the pallets 106A, 106B to repeatedly come into contact with the seat inserts 114A, 114B. Because the seat inserts 114A, 114B form interfaces with the pallet seals 116A, 116B, the seat inserts 114A, 114B have a comparatively small manufacturing tolerance (e.g., compared to other components of the pressure and vacuum relief valve 100, etc.) to reduce the likelihood of leaks through the relief assemblies 102, 104. In some examples, such repeated contact can cause the seat inserts 114A, 114B to wear (e.g., degrade, crack, abrade, etc.), which can reduce the efficacy of the seal formed between the pallets 106A, 106B, and the seat inserts 114A, 114B. As such, operation of the pressure and vacuum relief valve 100 can cause the wear of the seat inserts 114A, 114B and a need for them to be replaced. When the pressure and vacuum relief valve 100 is serviced, the seat inserts 114A, 114B can be replaced without replacing the entirety of the valve seat 112A, 112B.

FIG. 2 is a detailed view of the pressure relief assembly 102 of FIG. 1 in an example open position. In the illustrated example of FIG. 2, the pressure relief assembly 102 includes the first pallet 106A of FIG. 1, the weight 108A of FIG. 1, the valve stem 110A of FIG. 1, the first valve seat 112A of FIG. 1, and the example first seat insert 114A of FIG. 1. In the illustrated example of FIG. 2, the first seat insert 114A of FIG. 1 includes an example body portion 200, an example shoulder 216 extending radially outward from the body portion 200, and an example lip 204 (e.g., a ridge, a protrusion, etc.) extending axially (e.g., upward) from the body portion 200. In the illustrated example of FIG. 2, the first valve seat 112A includes an example end 215 having an example end surface 220. In the illustrated example of FIG. 2, the first valve seat 112A is disposed in an example opening 214 of the end 215 (e.g., the first valve seat 112A is disposed on the end 215, etc.). In the illustrated example of FIG. 2, the opening 214 extends annularly around the valve seat 112A and includes an example cavity 206, an example first surface 208, an example second surface 210, and an example third surface 212. While the configuration of FIG. 2 illustrates the pressure relief assembly 102, it should be appreciated that the associated seat insert configuration of FIG. 2 can also be implemented in accordance with the vacuum relief assembly 104 of FIG. 1.

In the illustrated example of FIG. 2, the first seat insert 114A is disposed in the opening 214. In some examples, the first seat insert 114A is disposed in the opening 214 via an interference fit. In some examples, the first seat insert 114A can be coupled to the valve seat 112A via a shrink fit (e.g., formed by heating the valve seat 112A to expand the valve seat 112A such that the first seat insert 114A can be disposed therein, etc.). In some such examples, prior to assembly, the opening 214 has a smaller cross-sectional area than the first seat insert 114A at room temperature. In some such examples, after assembly, the valve seat 112A contracts, which compresses the first seat insert 114A and exerts a strain thereon. In some such examples, the compression of the valve seat 112A retains the first seat insert 114A in a shrink fit.

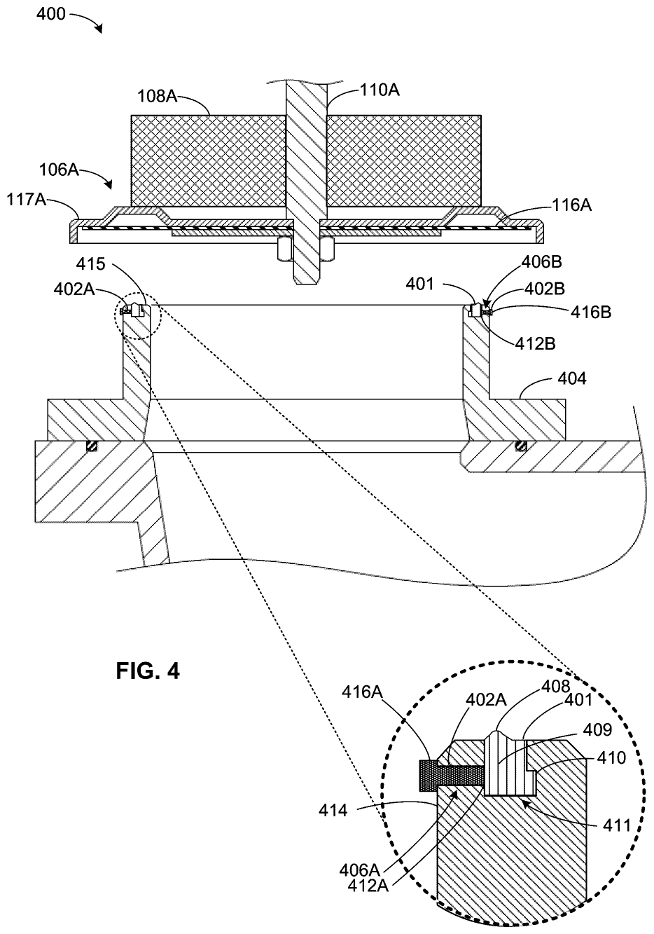

Additionally or alternatively, other means can be used to couple the first seat insert 114A to the first valve seat 112A. For example, the first seat insert 114A can be disposed within and/or coupled to the first valve seat 112A via one or more fasteners, one or more clamps. An example seat insert coupled to a valve seat via a clamp is described below in conjunction with FIG. 3. An example seat insert coupled to a valve seat via a plurality of fasteners is described below in conjunction with FIG. 4.

In the illustrated example of FIG. 2, the second surface 210 is parallel to the end surface 220. In the illustrated example of FIG. 2, the first surface 208 and the third surface 212 are perpendicular to the second surface 210 and the end surface 220. In the illustrated example of FIG. 2, the cavity 206 is disposed at an intersection of the first surface 208 and the second surface 210. The shoulder 216 of the seat insert 114A is a flange that is disposed within the first valve seat 112A. In the illustrated example of FIG. 2, the body portion 200 abuts the first surface 208 and the shoulder 216 abuts the second surface 210 and the third surface 212, such that the shoulder 216 extends into and is disposed within the cavity 206. In some examples, the shoulder 216 retains the first seat insert 114A within the opening 214. In particular, the shoulder 216 and the cavity 206 prevent or limit the first seat insert 114A from being removed axially (e.g., upward) from the opening 214 during normal operation of the valve 100. In some examples, the shoulder 216 extends annularly around the circumference of the first seat insert 114A. In other examples, the shoulder 216 can extend around a portion of the circumference of the first seat insert 114A (e.g., in multiple discrete segments, in a continuous segment, etc.). In the illustrated example of FIG. 2, the first seat insert 114A has a generally L-shaped cross-section. In other examples, the first seat insert 114A can have any other suitably shaped cross-section. For example, the first seat insert 114A can have an I-shaped cross-section (e.g., the shoulder 216 is absent, etc.), a C-shaped cross-section (e.g., the first seat insert 114A includes a top flange, etc.)

In the illustrated example of FIG. 2, an example top surface 218 of the body portion 200 is generally flush or aligned with the end surface 220 of the first valve seat 112A. The lip 204 extends from the top surface 218 of the body portion 200. In the illustrated example of FIG. 2, the lip 204 is chamfered relative to the adjacent surfaces of the seat insert 114A. In other examples, the lip 204 can be filleted, and/or otherwise beveled relative to the adjacent surfaces of the seat inserts 114A. In the illustrated example of FIG. 2, the lip 204 extends annularly around the seat insert 114A. When the pressure relief assembly 102 is in a closed position, the first pallet seal 116A abuts the first seat insert 114A, such that lip 204 extends into and compresses the pallet seal 116A into a corresponding opening of the plate 117A, which prevents fluid flow through the first fluid flow path 126A.

In some examples, after repeated operation of the pressure relief assembly 102, the lip 204 can become worn. In some such examples, the first seat insert 114A can be removed from the opening 214. In some examples, if the first seat insert 114A is coupled to the first valve seat 112A via a shrink fit, the first valve seat 112A can be heated to facilitate the removal of the first valve seat 112A. In some examples, the thermal expansion of the first valve seat 112A causes the shoulder 216 to be freed from the cavity 206, which facilitates the removal of the first seat insert 114A. After the removal of the first seat insert 114A, a new seat insert and/or a repaired seat insert can be disposed within the opening 214 of the end 215 of the first valve seat 112A.

FIG. 3 is a detailed view of another example pressure relief assembly 300 implemented in accordance with the teachings of this disclosure. The example pressure relief assembly 300 can be used in conjunction with the pressure and vacuum relief valve 100 of FIG. 1 and is similar to the pressure relief assembly 102 of FIG. 1, except that the pressure relief assembly 300 includes an example seat insert 302, an example clamp 304, and an example valve seat 306. The pressure relief assembly 300 includes the example first pallet 106A of FIG. 1 and the example first pallet seal 116A. In the illustrated example of FIG. 3, the seat insert 302 includes an example body portion 310, an example shoulder 313 extending radially inward from the body portion 310, and an example lip 308 extending axially from the body portion 310. The body portion 310, the lip 308, and the shoulder 313 are similar to the body portion 200 of FIG. 2, the lip 204 of FIG. 2, and the shoulder 216 of FIG. 2, respectively, except as noted otherwise. In the illustrated example of FIG. 3, the valve seat 306 includes an example end 315, which includes an example first surface 314, an example second surface 316, and an example cavity 318, which are similar to the first surface 208 of FIG. 2, the example second surface 210 of FIG. 2, and the cavity 206 of FIG. 2, respectively, except as noted otherwise. While the configuration of FIG. 3 illustrates the example pressure relief assembly 300, it should be appreciated that the associated seat insert configuration can also be used in conjunction with a vacuum relief assembly similar to the vacuum relief assembly 104 of FIG. 1.

In the illustrated example of FIG. 3, the seat insert 302 is disposed on the end 315. The seat insert 302 is a removeable insert that is similar to the first seat insert 114A of FIGS. 1 and 2, except that the seat insert 302 is retained in compression via the clamp 304. In the illustrated example of FIG. 3, the seat insert 302 is further retained via an interference fit (e.g., friction, etc.) between the insert shoulder 313 and the interior surfaces of the cavity 318. Unlike the cavity 206 of FIG. 2 and the shoulder 216 of FIG. 2, the insert shoulder 313 and cavity 318 extend radially inward from the seat insert 302 and into the valve seat 306, respectively. In the illustrated example of FIG. 3, the seat insert 302 has a generally L-shaped cross-section. In other examples, the seat insert 302 can have any other suitable shaped cross-section. For example, the seat insert 302 can have an I-shaped cross-section (e.g., the shoulder 216 is absent, etc.), a C-shaped cross-section (e.g., the seat insert 302 includes a top flange, etc.).

In the illustrated example of FIG. 3, the valve seat 306 includes an example cylindrical portion 322 including the first surface 314. The example cavity 318 is disposed at an intersection of the first surface 314 and the second surface 316 and extends into the cylindrical portion 322. The seat insert 302 and the clamp 304 are disposed on and abut the second surface 316 of the valve seat 306. In the illustrated example of FIG. 3, the seat insert 302 is disposed between the cylindrical portion 322 and the clamp 304 (e.g., a first side of the seat insert 302 abuts the cylindrical portion 322 and a second side of the seat insert 302 abuts the clamp 304, etc.). In some examples, the valve seat 306 can include another cylindrical portion (not illustrated) disposed radially outward of the cylindrical portion 322, the seat insert 302, and the clamp 304.

The clamp 304 is an annular member that retains the seat insert 302 on the valve seat 306 via a compressive force (e.g., the clamp 304 is a compressive ring, etc.). That is, the clamp 304 applies a compressive force (e.g., a compressive pressure, etc.) radially inward on the seat insert 302, such that the seat insert 302 is forced into the cylindrical portion 322 of the valve seat 306. In the illustrated example of FIG. 3, the clamp 304 is a continuous annular ring. In some examples, the clamp 304 exerts a compressive force on the seat insert 302 because the clamp 304 has a smaller inner diameter than the diameter of the valve seat 306 at the outer surface of seat insert 302. To install the clamp 304, the clamp is expanded (e.g., stretched open, etc.), disposed on the second surface 316, and allowed to contract radially inward (e.g., relax, etc.), which exerts a retaining force on the seat insert 302. In some examples, the clamp 304 can be thermally expanded (e.g., heated, etc.), disposed on the second surface 316, and allowed to contract. In some such examples, the thermal contraction of the clamp 304 exerts a compressive force on the seat insert 302. Additionally or alternatively, the clamp 304 can be disposed on the valve seat 306 by mechanically stressing the clamp 304, such that the clamp 304 is elastically deformed to have a larger inner diameter. In some such examples, the clamp 304 is mechanically expanded (e.g., subjected to a radially applied outward stress, elastically deformed, strained, etc.), disposed on the second surface 316, and allowed to contract (e.g., elastically rebound, etc.). In some such examples, the mechanical contraction of the clamp 304 exerts a compressive force on the seat insert 302.

In some examples, the clamp 304 can be composed of multiple segments (e.g., multiple curved pieces, two semi-circular pieces, etc.). In some such examples, segments of the clamp 304 can be coupled via one or more fasteners, one or more chemical adhesives, etc. In some examples, the coupling of the segments of the clamp 304 can cause the clamp 304 to exert a compressive force on the seat insert 302. In some examples, the clamp 304 can include a ratcheting mechanism, which can be used to adjust the diameter of the clamp 304. In some such examples, the ratcheting mechanism can be used to reduce the diameter of the clamp 304 after the clamp 304 has been disposed on the second surface 316 of the valve seat 306. In some examples, the clamp 304 can be threadedly coupled to the seat insert 302 and/or the valve seat 306. In some such examples, the threaded coupling of the clamp to the seat insert 302 and/or the valve seat 306 retains the seat insert 302 to the valve seat 306. In some examples, after repeated operation of the pressure relief assembly 300, the lip 308 of the seat insert 302 can become worn. In some such examples, the clamp 304 can be removed, which facilitates the removal of the seat insert 302 (e.g., to be scrapped, to be repaired, etc.). After the removal of the seat insert 302, a new seat insert and/or a repaired seat insert can be disposed within the seat and retained after coupling the clamp 304 to the valve seat 306.

FIG. 4 is a detailed view of another example pressure relief assembly 400 implemented in accordance with the teachings of this disclosure. The example pressure relief assembly 400 can be used in conjunction with the pressure and vacuum relief valve 100 of FIG. 1 and is similar to the pressure relief assembly 102 of FIG. 1, except that the pressure relief assembly 400 includes an example seat insert 401, an example first fastener 402A, an example second fastener 402B, and an example valve seat 404. The pressure relief assembly 400 includes the example first pallet 106A of FIG. 1, the example first weight 108A of FIG. 1, the example first valve seat 112A of FIG. 1, the example first pallet seal 116A of FIG. 1, and the example first plate 117A of FIG. 1. The valve seat 404 is similar to the first valve seat 112A of FIGS. 1 and 2, except that the valve seat 404 includes an example first opening 406A and an example second opening 406B. The example seat insert 401 includes an example lip 408, an example body portion 409, and an example shoulder 410, which are similar to the example lip 204, the body portion 200, and the shoulder 216 of FIG. 2, respectively, except as indicated otherwise. In the illustrated example of FIG. 4, the valve seat 404 has an example end 415 having an example opening 411, which is similar to the opening 214 of FIG. 2 except as indicated otherwise. While the configuration of FIG. 4 illustrates the example pressure relief assembly 400, it should be appreciated that the associated seat insert configuration can also be used in conjunction with a vacuum relief assembly similar to the vacuum relief assembly 104 of FIG. 1.

In the illustrated example of FIG. 4, the seat insert 401 is disposed on the end 415. In the illustrated example of FIG. 4, the seat insert 401 is a removeable insert that is similar to the first seat insert 114A of FIGS. 1 and 2, except that the seat insert 401 is retained in the valve seat 404 via the fasteners 402A, 402B and the insert shoulder 410. The fasteners 402A, 402B are coupled to the valve seat 404 via the openings 406A, 406B, respectively. The openings 406A, 406B are through holes that extend from an exterior of the valve seat 404 to an interior of the opening 411 of the valve seat 404. In the illustrated example of FIG. 4, the openings 406A, 406B extend from an example radially outer surface 414 of valve seat 404 to the opening 411 that receives the seat insert 401. In the illustrated example of FIG. 4, the fasteners 402A, 402B include an example first fastener end 412A and an example second fastener end 412B, respectively.

In the illustrated example of FIG. 4, the fastener ends 412A, 412B extend through the valve seat 404 and abut the seat insert 401. The fasteners 402A, 402B, via the fastener ends 412A, 412B, abut the seat insert 401, apply a compressive force to the seat insert 401, which retains the seat insert 401 in the opening 411. In some examples, the fasteners 402A, 402B are screws or bolts. In some such examples, the openings 406A, 406B include threads, which facilitate the threaded coupling of the fasteners 402A, 402B. In other examples, the fasteners 402A, 402B can be any other type of fasteners (e.g., rivets, etc.). In the illustrated example of FIG. 4, the fasteners 402A, 402B include an example first head 416A and an example second head 416B, which abut the radially outer surface 414. In some examples, the heads 416A, 416B are absent.

To remove, service, and/or replace the seat insert 401, the fasteners 402A, 402B can be removed from the openings 406A, 406B, which facilitates the removal of the seat insert 401 from the pressure relief assembly 400. After the removal of the seat insert 401, a new seat insert and/or a repaired seat insert can be disposed within the valve seat 404 and retained after coupling the fasteners 402A, 402B within the valve seat 404. While the pressure relief assembly 400 of FIG. 4 includes two fasteners (e.g., the fasteners 402A, 402B, etc.) that are received by two corresponding openings (e.g., the openings 406A, 406B, etc.), in other examples, the pressure relief assembly 400 can include a different number of fasteners and/or openings (e.g., one fastener and hole, three fasteners and holes, 10 fasteners and holes, etc.).

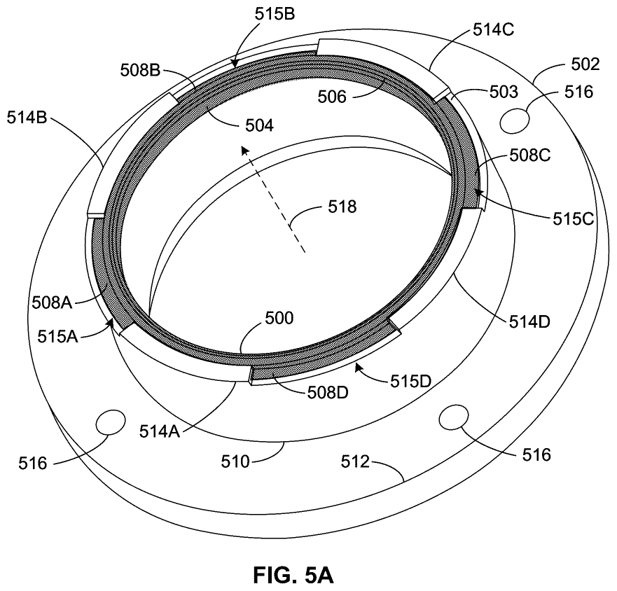

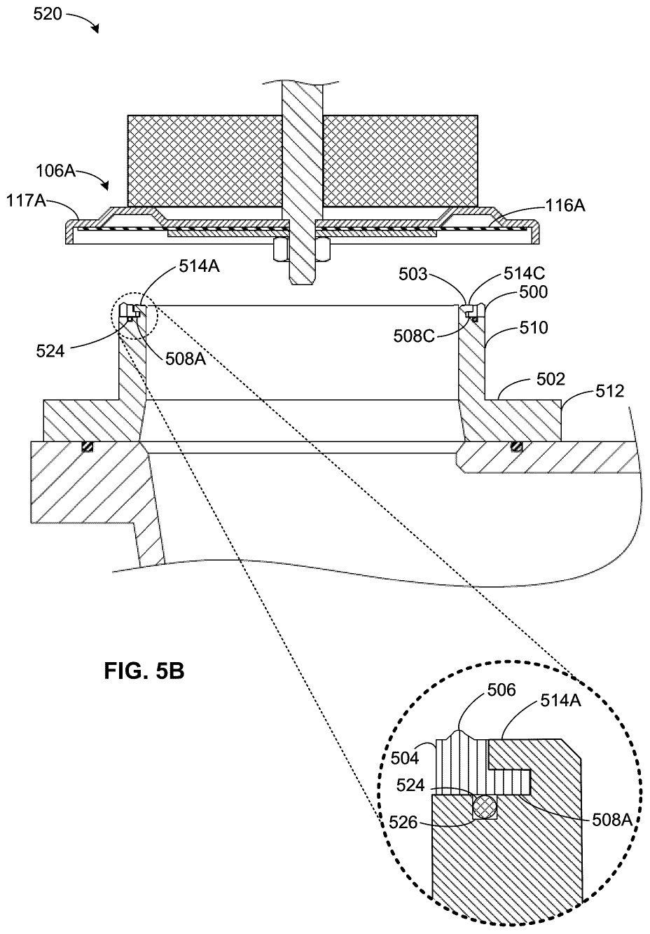

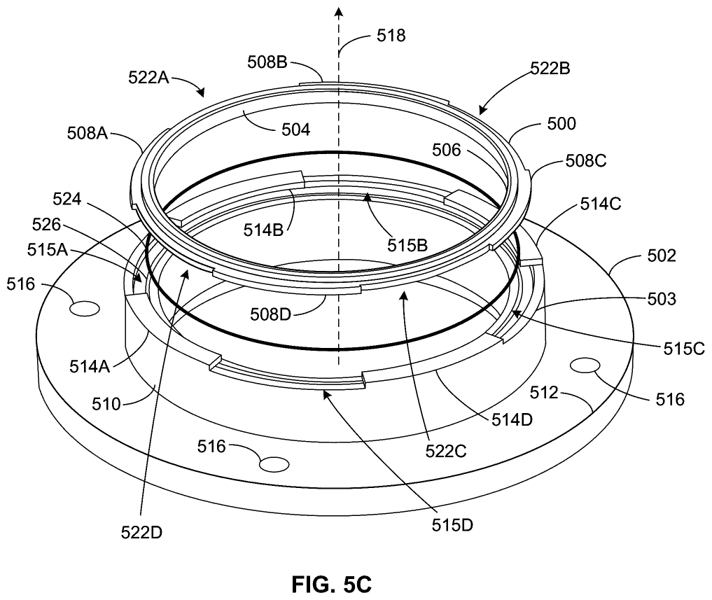

FIG. 5A is a perspective view of another example seat insert 500 and example valve seat 502 implemented in accordance with the teachings of this disclosure. In the illustrated example of FIG. 5A, the seat insert 500 is disposed on and rotatably coupled to an example end 503 of the valve seat 502 and forms a twist lock interface therewith. In the illustrated example of FIG. 5A, the seat insert 500 is a removeable insert that includes an example body 504, an example lip 506 extending axially upward from the body 504, an example first insert shoulder 508A, an example second insert shoulder 508B, an example third insert shoulder 508C, and an example fourth insert shoulder 508D. The shoulders 508A-508D extend radially outward from the body 504. In the illustrated example of FIG. 5A, the valve seat 502 includes an example cylindrical portion 510 and an example seat flange 512 extending radially outward from the cylindrical portion 510. The seat flange 512 has a plurality of holes 516 to receive fasteners (e.g., bolts) to couple the valve seat 502 to a valve body. The end 503 of the valve seat 502 includes an example first boss 514A, an example second boss 514B, an example third boss 514C, an example fourth boss 514D. The end 503 of the valve seat 502 further includes an example first opening 515A between the first boss 514A and second boss 514B, an example second opening 515B between the second boss 514B and third boss 514C, an example third opening 515C between the third boss 514C and the fourth boss 514D, and an example fourth opening 515D between the fourth boss 514D and the first boss 514A.

The example seat insert 500 of FIG. 5A and the example valve seat 502 of FIG. 5A can be used in conjunction with the pressure and vacuum relief valve 100 of FIG. 1 and implement one or both of the valve seats 112A, 112B of FIG. 1. Particularly, the seat insert 500 and valve seat 502 can be used in one or both of the pressure relief assembly 102 of FIG. 1 and/or the vacuum relief assembly 104 of FIG. 1.

In the illustrated example of FIG. 5A, the valve seat 502 includes the bosses 514A, 514B, 514C, 514D disposed on and extending radially inward from the end 503 of the cylindrical portion 510 of the valve seat 502. In the illustrated example of FIG. 5A, the valve seat 502 includes four bosses (e.g., the bosses 514A, 514B, 514C, 514D, etc.), which are spaced equidistant from each other about the circumference of the end 503. In other examples, the valve seat 502 can include any suitable number bosses (e.g., 1 boss, two bosses, three bosses, five bosses, ten bosses, etc.) having any other suitable distribution (e.g., evenly spaced distribution, an unevenly spaced distribution, etc.). In some such examples, the seat insert 500 can include a corresponding number of insert shoulders having a complimentary distribution to permit the removal and locking of the seat insert 500 in the valve seat 502. In some examples, the valve seat 502 and the bosses 514A, 514B, 514C, 514D are integral (e.g., formed via a casting, formed via additive manufacturing, etc.). In other examples, some or all of the bosses 514A, 514B, 514C, 514D can be manufactured separately and coupled to the end 503 (e.g., via one or more fasteners, via one or more welds, via one or more interference fits, etc.). In some such examples, the bosses 514A, 514B, 514C, 514D can be composed of a different material than the valve seat 502.

The valve seat 502 can be coupled to the body of a relief valve (e.g., the pressure and vacuum relief valve 100, etc.) via one or more fasteners (e.g., bolts, rivets, etc.) extending through corresponding ones of the plurality of holes 516. Additionally or alternatively, the valve seat 502 can be coupled to the body of a relief valve via one or more welds, one or more interference fits, one or more mechanical fits, etc. In some such examples, a seal (e.g., the valve seat seals 118A, 118B of FIG. 1, etc.) can be disposed between the valve seat 502 and the body. In other examples, the valve seat 502 and the body can be integral (e.g., a single cast part, an additively manufactured part, etc.).

The valve seat 502 and the seat insert 500 have a first relative position and a second relative position, which are rotationally displaced via an angular displacement about an example axis 518. In the illustrated example of FIG. 5A, the axis 518 is the centerline axis of the valve seat 502. In the illustrated example of FIG. 5A, the seat insert 500 and the valve seat 502 are in the first relative position. Particularly, in the illustrated example of FIG. 5A, the insert shoulders 508A, 508B, 508C, 508D of the seat insert 500 are rotationally aligned with the openings 515A, 515B, 515C, 515D, respectively. The first relative position of the seat insert 500 and the valve seat 502 (e.g., the angular alignment of the insert shoulders 508A, 508B, 508C, 508D and the openings 515A, 515B, 515C, 515D, etc.) facilitates the removal of the seat insert 500 from the valve seat 502 and/or the removal/replacement thereof. That is, in the first relative position depicted in the illustrated example of FIG. 5A, the seat insert 500 can be removed from the valve seat 502 by displacing the valve seat 502 along the axis 518. Similarly, the seat insert 500 and/or a replacement seat insert can be disposed within the end 503 of the valve seat 502 by aligning the seat insert 500 and the valve seat 502 in the first relative position (e.g., wherein the insert shoulders 508A, 508B, 508C, 508D are radially aligned with the openings 515A, 515B, 515C, 515D, respectively, etc.) and translating the seat insert 500 along the axis 518.

In the second relative position, the seat insert 500 is rotated 90° (e.g., a quarter turn, etc.) such that the insert shoulders 508A, 508B, 508C, 508D and the bosses 514A, 514B, 514C, 514D are circumferentially aligned. That is, the insert shoulders 508A, 508B, 508C, 508D of the seat insert 500 are disposed between and abut corresponding ones of the bosses 514A, 514B, 514C, 514D and the body 504 of the valve seat 502. The abutment of the bosses 514A, 514B, 514C, 514D and the insert shoulders 508A, 508B, 508C, 508D prevents the translation of the seat insert 500 along the axis 518 and retains the seat insert 500 in the valve seat 502. In the first relative position, the bosses 514A, 514B, 514C, 514D and the insert shoulders 508A, 508B, 508C, 508D do not abut, which enables the translation of the seat insert 500 in the valve seat 502. Therefore, the seat insert 500 and the valve seat 502 form a twist lock interface. An example of the seat insert 500 and example valve seat 502 in the second relative position is described below in conjunction with FIG. 5B.

In some examples, the seat insert 500 and/or the valve seat 502 can include one or more features that retain the seat insert 500 in the second relative position during operation. For example, the valve seat 502 and/or the seat insert 500 can include one or more holes (not illustrated) formed on an outer surface and/or inner surface of the valve seat 502 and/or the seat insert 500 that are configured to receive a fastener and/or pin. In some such examples, inserting one or more fasteners and/or pins in the one or more holes can lock the relative position of the seat insert 500 and/or the valve seat 502. Additionally or alternatively, the seat insert 500 and/or valve seat 502 can include one or more grooves and/or bosses disposed therein. In some such examples, the interface between the bosses and the grooves increases the friction between the seat insert 500 and the valve seat 502, which increases the amount of force required to change the relative position of the seat insert 500 and valve seat 502. In some examples, the seat insert 500 and the valve seat 502 can be coupled be a threaded connection (e.g., between an inner surface of the valve seat 502 and an outer surface of the seat insert 500, etc.), which increases the amount of force required to change the relative position of the seat insert 500 and valve seat 502. In some such examples, the insert shoulders 508A, 508B, 508C, 508D and the bosses 514A, 514B, 514C, 514D can be absent.

FIG. 5B is a detailed view of a cross-section of a pressure relief vacuum assembly 520 including the seat insert 500 of FIG. 5A and the valve seat 502 of FIG. 5A. The pressure relief vacuum assembly 520 can be used in conjunction with a relief valve similar to the pressure and vacuum relief valve 100 of FIG. 1. In the illustrated example of FIG. 5B, the pressure relief vacuum assembly 520 also includes the first pallet 106A of FIGS. 1 and 2, the first weight 108A of FIGS. 1 and 2, the first valve stem 110A of FIGS. 1 and 2, the first pallet seal 116A of FIGS. 1 and 2, and the first plate 117A of FIGS. 1 and 2. While the configuration of FIG. 5B illustrates a pressure relief assembly (e.g., the pressure relief vacuum assembly 520, etc.), it should be appreciated that the seat insert 500 and the valve seat 502 can also be used in conjunction with a vacuum relief assembly similar to the vacuum relief assembly 104 of FIG. 1.

In the illustrated example of FIG. 5B, the first insert shoulder 508A, the second insert shoulder 508B (not visible in FIG. 5B), the third insert shoulder 508C, and the fourth insert shoulder 508D (not visible in FIG. 5B) are axially aligned with the first boss 514A, the second boss 514B (not visible in FIG. 5B), the third boss 514C, and the fourth boss 514D (not visible in FIG. 5B), such that the seat insert 500 is retained in the valve seat 502. During operation, the first pallet 106A moves (e.g., translates, etc.) along the first valve stem 110A between an open position (e.g., spaced from the seat insert 500 and valve seat 502, etc.) and a closed position (e.g., abutting the seat insert 500, etc.). In the illustrated example of FIG. 5B, the pressure relief vacuum assembly 520 is in the open position, such that first pallet seal 116A is spaced from the lip 506 of the seat insert 500. When the pressure exerted by the pallet 106A by fluids within the valve body 101 (e.g., the pressure of the contained fluid is greater than the pressure exerted by the first weight 108A, etc.), the first pallet 106A moves upward along the first valve stem 110A, the pressure relief vacuum assembly 520 opens, and fluid is vented through the pressure relief vacuum assembly 520. When the pressure relief valve assembly 520 is in the closed position, the pallet seal 116A abuts the lip 506 and forms a seal therewith (e.g., the pallet seal 116A sealing engages with the lip 506 when the pressure relief valve assembly 520 is closed, etc.).

FIG. 5C is an exploded view of the seat insert 500, the example valve seat 502, and an example insert seal 524. In the illustrated example of FIG. 5C, the seat insert 500 includes an example first gap 522A disposed between the first shoulder 508A and the second shoulder 508B, an example second gap 522B disposed between the second shoulder 508B and the third shoulder 508C, an example third gap 522C disposed between the third shoulder 508C and the fourth shoulder 508D, and an example fourth gap 522D disposed between the fourth shoulder 508D and the first shoulder 508A. In the first relative position, illustrated in FIGS. 5A and 5C (e.g., a position that permits the seat insert 500 to inserted and removed from the valve seat 502, etc.), the gaps 522A, 522B, 522C, 522D are rotationally aligned with the bosses 514A, 514B, 514C, 514D, respectively. In the second relative position (e.g., a position that inhibits the translation of the seat insert 500 relative the valve seat 502 along the axis 518, etc.), illustrated in FIG. 5B, the gaps 522A, 522B, 522C, 522D are rotationally aligned with the openings 515A, 515B, 515C, 515D, respectively, and the bosses 514A, 514B, 514C, 514D are aligned with the shoulders 508A, 508B, 508C, 508D, respectively.

In the illustrated example of FIGS. 5B and 5C, the example insert seal 524 is disposed in an example trough 526 (e.g., a seal gland) in the end 503 of the valve seat 502. In the illustrated example of FIGS. 5B and 5C, the insert seal 524 abuts the valve seat 502 and the seat insert 500 and forms a fluid seal therebetween. The insert seal 524 mitigates (e.g., prevents, reduces, etc.) leaks between the valve seat 502 and the seat insert 500. In the illustrated example of FIG. 5B, the trough 526 extends circumferentially around the end 503 of the valve seat 502. In some examples, the insert seal 524 and the through 526 can be absent.

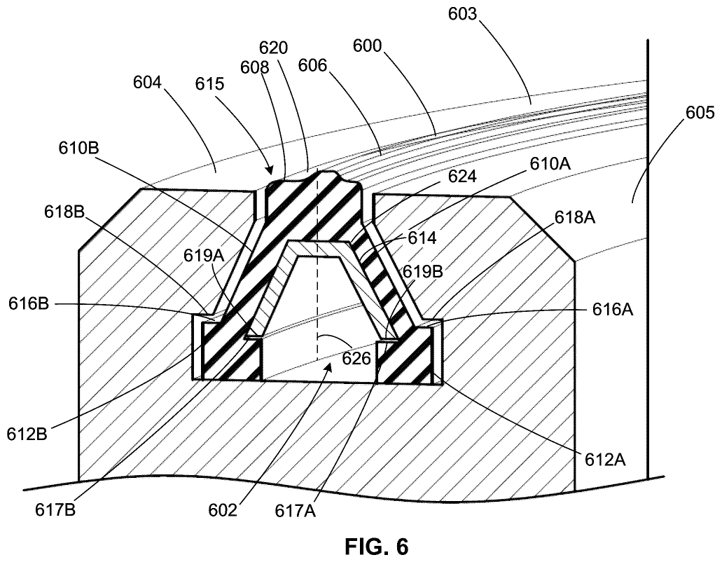

FIG. 6 is a perspective cross-sectional view of another example seat insert 600 implemented in accordance with the teachings of this disclosure. In the illustrated example of FIG. 6, the seat insert 600 is disposed within an example opening 602 in an example end surface 603 of an example valve seat end 604 of an example valve seat 605 (e.g., the seat insert 600 is disposed on the valve seat end 604, etc.). In the illustrated example of FIG. 6, the seat insert 600 is a removeable insert that includes an example insert body 608, an example lip 606 extending axially (e.g., upward) from the insert body 608, an example first arm 610A extending from the insert body 608, an example second arm 610B extending from the insert body 608, an example first boss 612A extending from the first arm 610A, an example second boss 612B extending from the second arm 610B, and an example spring 614. In the illustrated example of FIG. 6, the seat insert 600 is an assembly composed of an example main portion 615, which includes the insert body 608, the arms 610A, 610B, and the bosses 612A, 612B, and the spring 614. In other examples, the seat insert 600 can include more than two discrete components. In other examples, the spring 614 is integral with the other components of the seat insert 600.

In the illustrated example of FIG. 6, the bosses 612A, 612B include an example first lateral flange 616A and an example lateral second flange 616B, respectively, and an example first medial flange 617A and an example second medial flange 617B, respectively. In the illustrated example of FIG. 6, the valve seat 605 includes an example first retention surface 618A and an example second retention surface 618B within the opening 602. In the illustrated example of FIG. 6, the spring 614 includes an example first end 619A and an example second end 619B. The example valve seat 605 can be used in conjunction with the pressure and vacuum relief valve 100 of FIG. 1 and implement one or both of the valve seats 112A, 112B of FIG. 1. Particularly, the seat insert 600 and valve seat 605 can be used in one or both of the pressure relief assembly 102 of FIG. 1 and/or the vacuum relief assembly 104 of FIG. 1.

The seat insert 600 is an annular member that is disposed within the opening 602 and extends circumferentially around the valve seat 605. In the illustrated example of FIG. 6, the seat insert 600 is constructed as a monolithic structure (e.g., the insert body 608, the arms 610A, 610B, and the bosses 612A, 612B are integral). In other examples, one or more of the insert body 608, the arms 610A, 610B, and the bosses 612A, 612B can be constructed as separate components and coupled together via one or more fasteners, one or more interference fits, one or more chemical adhesives, etc. In the illustrated example of FIG. 6, the seat insert 600 has a generally V-shaped cross section (e.g., the seat insert 600 is a V-shaped member, etc.) and the opening 602 has a generally complimentary shape (e.g., the opening 602 also has a generally V-shaped cross section, etc.). In other examples, the seat insert 600 and/or the seat insert 600 can have any other suitable shape. Like the seat inserts 114A, 114B of FIG. 1, the seat insert 600 is removably disposed within the opening 602 and includes the lip 606 (e.g., similar to the lip 204 of FIG. 2, etc.) to form a sealing interface with a corresponding pallet of a relief assembly (e.g., a seal with one of the pallet seals 116A, 116B of the relief assemblies 102, 104, etc.). In some examples, the seat insert 600 can be composed of a generally wear-resistant flexible material including a plastic (e.g., acrylonitrile butadiene styrene (ABS), ethylene tetrafluoroethylene (ETFE), a glass epoxy, a high-strength polyethylene, a resin including polyphenylene and/or polystyrene, etc.), a metal (e.g., stainless steel, aluminum, etc.), etc. In the illustrated example of FIG. 6, there is a gap between the sides of the seat insert 600 and the interior surfaces of the opening 602. It should be appreciated that this gap is for illustrative purposes only. In operation, the insert body 608, the arms 610A, 610B, and/or the bosses 612A, 612B abut the interior surfaces of the opening 602.

The insert body 608 is the portion of the seat insert 600 that extends from the opening 602. The insert body 608 is a generally annular member that extends circumferentially around the valve seat 605. The insert body 608 includes the example lip 606 that extends from an example first surface 620 of the insert body 608. In the illustrated example of FIG. 2, the first surface 620 of the insert body 608 is generally flush with the example valve seat end 604 of the valve seat 605. In other examples, the first surface 620 can be recessed from the valve seat end 604 of the valve seat 605 and/or extending from the valve seat end 604 of the valve seat 605. The arms 610A, 610B extend between the insert body 608 to the bosses 612A, 612B, respectively. The arms 610A, 610B are generally flat members (e.g., sheets, etc.) that extend circumferentially around the valve seat 605. In other examples, the arms 610A, 610B can have any other suitable shape and/or orientation. In some examples, the arms 610A, 610B can include features (not illustrated) that facilitate the installation and removal of the seat insert 600. The bosses 612A, 612B are portions of the seat insert 600 that retain the seat insert 600 within the opening 602 and the spring 614 within the seat insert 600. The bosses are generally annular members that extends circumferentially around the valve seat 605.

The spring 614 is a flat spring abutting an example interior surface 624 of the seat insert 600. In the illustrated example of FIG. 6, the spring 614 is compressed and inserted into the seat insert 600, such that the body of the spring 614 abuts the interior surface 624 and the ends 619A, 619B abut the medial flanges 617A, 617B, respectively. In some such examples, the abutment of the spring 614 on the interior surface 624 and abutment of the ends 619A, 619B on the medial flanges 617A, 617B retain the spring 614 within the seat insert 600. The compression of the spring 614 within the seat insert 600 biases the seat insert 600 in tension. In the illustrated example of FIG. 6, the tensile force of the seat insert 600 causes the lateral flanges 616A, 616B to abut the retention surfaces 618A, 618B, which retains the seat insert within the opening 602. In the illustrated example of FIG. 6, the spring 614 is a flat spring compressed of a single continuous member. In other examples, the spring 614 can be implemented by any suitable type of spring (e.g., a laminated spring, a coil spring, a conical spring, an arc spring, etc.) that exerts a tensile force on the arms 610A, 610B. The spring 614 can be composed of any suitable material, including spring steel, copper, brass, bronze, a nickel alloy, etc.

The seat insert 600 can be inserted into the opening 602 by applying a compressive force to the arms 610A, 610B against the biasing tensile force of the spring 614, which displaces the arms 610A, 610B and the bosses 612A, 612B toward an example center diameter 626 of the seat insert 600. After compressing the seat insert 600, the bosses 612A, 612B can be inserted to the opening 602 and the compressive force exerted on the seat insert 600 can be released. After inserting the seat insert 600 into the opening 602, the lateral flanges 616A, 616B of the bosses 612A, 612B come into contact with the retention surfaces 618A, 618B and retain the seat insert 600 within the opening 602 (e.g., the seat insert 600 is compressive disposed within the opening 602, etc.). To remove, service, and/or replace the seat insert 600, a compressive force can be applied to the arms 610A, 610B (e.g., via a tool inserted along the sides of the insert body 608, etc.) against the biasing tensile force of the spring 614, which displaces the arms 610A, 610B and the bosses 612A, 612B toward an example center diameter 626. In some such examples, the compressive force causes the lateral flanges 616A, 616B to stop abutting the retention surfaces 618A, 618B, facilitating the removal of the seat insert 600 from the opening 602. After the removal of the first seat insert 600, a new seat insert and/or a repaired seat insert can be disposed within the seat.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another.

As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified herein.

Removeable valve seat inserts for pressure and vacuum relief valves are disclosed herein. Further examples and combinations thereof include the following:

Example 1 includes a relief valve comprising a valve body defining a fluid passageway between a first opening and a second opening, a valve seat coupled to the valve body at the first opening of the valve body, the valve seat having a cylindrical body, a seat insert disposed on an end of the valve seat, and a pallet moveable, based on a pressure differential across the pallet, between a closed position in which the pallet is engaged with the seat insert to block fluid flow through the valve seat and an open position in which the pallet is spaced from the seat insert to enable fluid flow through the valve seat.

Example 2 includes the relief valve of example 1, wherein the seat insert is coupled to the valve seat via a shrink fit.

Example 3 includes the relief valve of example 1, wherein the pallet includes a pallet seal and the seat insert has a lip to engage the pallet seal when the pallet is in the closed position.

Example 4 includes the relief valve of example 1, wherein the valve seat includes an opening defined by a first surface, and a second surface perpendicular to the first surface, a third surface parallel to the first surface and perpendicular to the second surface, and a cavity disposed at an intersection of the first surface and the second surface.

Example 5 includes the relief valve of example 4, wherein the seat insert includes a shoulder disposed within the cavity.

Example 6 includes the relief valve of example 1, wherein the seat insert is disposed in a first opening formed in the end of the valve seat, the relief valve further including a fastener having a fastener end abutting the seat insert, the fastener extending through a second opening in an outer surface of the valve seat.

Example 7 includes the relief valve of example 1, further including a ring abutting an outer surface of the seat insert, the ring applying a compressive force to the seat insert.

Example 8 includes the relief valve of example 1, wherein the seat insert is rotatably coupled to the end of the valve seat.

Example 9 includes the relief valve of example 8, wherein the seat insert includes a boss extending radially inward from the end, the boss abutting the seat insert in a first relative position, and the boss not abutting the seat insert in a second relative position.

Example 10 includes the relief valve of example 1, wherein the end of the valve seat has an opening, and wherein the seat insert is disposed in the opening and has a V-shaped cross section.

Example 11 includes a pressure and vacuum relief valve including a valve body defining a fluid passageway between a first opening, a second opening, and a third opening, the first opening to be fluidly connected to a pressure system, a first relief assembly to control fluid flow through the second opening, the first relief assembly including a valve seat having an end, a removeable insert disposed within the end, the removeable insert extending circumferentially within the valve seat, and a flow control member moveable between an open position and a closed position, the flow control member to form an interface with the removeable insert in the closed position, and a second relief assembly to control fluid flow through the third opening.

Example 12 includes the relief valve of example 11, wherein the valve seat is a first valve seat, the end is a first end, the flow control member is a first flow control member, the removeable insert is a first removeable insert, the open position is a first open position, the closed position is a first closed position, the interface is a first interface, and wherein the second relief assembly further includes a second valve seat including an end, a second flow control member moveable between a second open position and a second closed position, the second flow control member to form a second interface with the second valve seat in the second closed position, and a second removeable insert disposed within the end.

Example 13 includes the relief valve of example 12, wherein the first removeable insert and the second removeable insert are interchangeable.

Example 14 includes the relief valve of example 11, wherein the first relief assembly is a pressure relief assembly and the second relief assembly is a vacuum relief assembly.

Example 15 includes the relief valve of example 11, wherein the end includes an opening defined by a first surface, a second surface perpendicular to the first surface, a third surface parallel to the first surface and perpendicular to the second surface, and a cavity disposed at an intersection the first surface and the second surface.

Example 16 includes the relief valve of example 15, wherein the removeable insert includes a flange disposed within the cavity.

Example 17 includes the relief valve of example 11, further including a clamp abutting the removeable insert, the clamp applying a compressive force to the removeable insert, and the abutment of the clamp and the removeable insert retains the removeable insert on the valve seat.

Example 18 includes the relief valve of example 11, further including a fastener extending through the valve seat, and an abutment of the fastener and the removeable insert retains the removeable insert to the valve seat.

Example 19 includes the relief valve of example 11, wherein the removeable insert is retained to the valve seat via a twist lock interface.

Example 20 includes the relief valve of example 11, wherein the removeable insert is a V-shaped member compressively disposed within an opening in the valve seat.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. A relief valve comprising:
a valve body defining a fluid passageway between a first opening and a second opening;
a valve seat coupled to the valve body at the first opening of the valve body, the valve seat having a cylindrical body;
a seat insert disposed on an end of the valve seat; and
a pallet moveable, based on a pressure differential across the pallet, between a closed position in which the pallet is engaged with the seat insert to block fluid flow through the valve seat and an open position in which the pallet is spaced from the seat insert to enable fluid flow through the valve seat.

2. The relief valve of claim 1, wherein the seat insert is coupled to the valve seat via a shrink fit.

3. The relief valve of claim 1, wherein the pallet includes a pallet seal and the seat insert has a lip to engage the pallet seal when the pallet is in the closed position.

4. The relief valve of claim 1, wherein the valve seat includes an opening defined by:
a first surface; and
a second surface perpendicular to the first surface;
a third surface parallel to the first surface and perpendicular to the second surface; and
a cavity disposed at an intersection of the first surface and the second surface.

5. The relief valve of claim 4, wherein the seat insert includes a shoulder disposed within the cavity.

6. The relief valve of claim 1, wherein the seat insert is disposed in a third opening formed in the end of the valve seat, the relief valve further including a fastener having a fastener end abutting the seat insert, the fastener extending through a fourth opening in an outer surface of the valve seat.

7. The relief valve of claim 1, further including a ring abutting an outer surface of the seat insert, the ring applying a compressive force to the seat insert.

8. The relief valve of claim 1, wherein the seat insert is rotatably coupled to the end of the valve seat.

9. The relief valve of claim 8, wherein the seat insert includes a boss extending radially inward from the end, the boss abutting the seat insert in a first relative position, and the boss not abutting the seat insert in a second relative position.

10. The relief valve of claim 1, wherein the end of the valve seat has an opening, and wherein the seat insert is disposed in the opening and has a V-shaped cross section.

11. A pressure and vacuum relief valve including:
a valve body defining a fluid passageway between a first opening, a second opening, and a third opening, the first opening to be fluidly connected to a pressure system;
a first relief assembly to control fluid flow through the second opening, the first relief assembly including:
a valve seat having an end;
a removeable insert disposed within the end, the removeable insert extending circumferentially within the valve seat; and
a flow control member moveable between an open position and a closed position, the flow control member to form an interface with the removeable insert in the closed position; and
a second relief assembly to control fluid flow through the third opening.

12. The pressure and vacuum relief valve of claim 11, wherein the valve seat is a first valve seat, the end is a first end, the flow control member is a first flow control member, the removeable insert is a first removeable insert, the open position is a first open position, the closed position is a first closed position, the interface is a first interface, and wherein the second relief assembly further includes:
a second valve seat including a second end;
a second flow control member moveable between a second open position and a second closed position, the second flow control member to form a second interface with the second valve seat in the second closed position; and
a second removeable insert disposed within the second end.

13. The pressure and vacuum relief valve of claim 12, wherein the first removeable insert and the second removable insert are interchangeable.

14. The pressure and vacuum relief valve of claim 11, wherein the first relief assembly is a pressure relief assembly, and the second relief assembly is a vacuum relief assembly.

15. The pressure and vacuum relief valve of claim 11, wherein the end includes an opening defined by:
a first surface;
a second surface perpendicular to the first surface;
a third surface parallel to the first surface and perpendicular to the second surface; and
a cavity disposed at an intersection the first surface and the second surface.

16. The pressure and vacuum relief valve of claim 15, wherein the removeable insert includes a flange disposed within the cavity.

17. The pressure and vacuum relief valve of claim 11, further including a clamp abutting the removeable insert, the clamp applying a compressive force to the removeable insert, and the abutment of the clamp and the removeable insert retains the removeable insert on the valve seat.

18. The pressure and vacuum relief valve of claim 11, further including a fastener extending through the valve seat, and an abutment of the fastener and the removeable insert retains the removeable insert to the valve seat.

19. The pressure and vacuum relief valve of claim 11, wherein the removeable insert is retained to the valve seat via a twist lock interface.

20. The pressure and vacuum relief valve of claim 11, wherein the removeable insert is a V-shaped member compressively disposed within an opening in the valve scat.
